(19) United States
(12) Patent Application Publication
(10) Pub. No.: US 2012/0074343 A1
(43) Pub. Date: Mar. 29, 2012

(54) TAP

(76) Inventor: Christiaan Johannes Meintjes, Malmesbury (ZA)

(21) Appl. No.: 13/321,610

(22) PCT Filed: Jun. 12, 2009
(86) PCT No.: PCT/IB2009/052523

§ 371 Date: Dec. 8, 2011

(51) Int. Cl. F16K 1/00; B67D 7/06

(52) U.S. Cl. 251/318; 222/505

(57) ABSTRACT

A tap (10) for controlling the dispensing of a liquid from a bag-in-box container, comprises a valve body (18) and valve mechanism which includes a valve member (20), a spindle (22) and a valve actuation member (24). The valve body (18) comprises a cylindrical passage-defining portion (26) and a valve housing portion (28). The valve housing portion (28) defines an inlet opening (32) and the portion (26) defines an outlet opening (52) through which liquid can be dispensed. An inner side of the portion (26) at an end (44) thereof, defines an annular sealing formation against which the valve member (20) can be seated in a closed position thereof thereby blocking liquid flow to the outlet opening (52). Rotation of the valve actuation member (24) causes rotation and axial displacement of the spindle (22) and thereby the valve member for displacing the valve member between its closed position and an open position allowing liquid flow to the outlet opening.

### FIELD OF INVENTION

This invention relates to a tap for controlling the dispensing of a liquid from a container.

### SUMMARY OF INVENTION

According to the invention there is provided a tap for controlling the dispensing of a liquid from a container, the tap including:

a valve body having an open first end and an opposite open second end, the first end being connectable to an outlet opening of the container and defining an inlet opening, the valve body defining an outlet opening between the first and second ends, the valve body further defining a tubular fluid flow passage and a valve seat between the inlet and outlet openings;

a valve mechanism including a valve member which is mounted within the valve body; a spindle which is connected to the valve member and which is rotatably mounted within the valve body; and a valve actuation member which is rotatably mounted to the valve body at the second end thereof and connected to the spindle in an arrangement wherein rotation of the valve actuating member causes rotation of the spindle and thereby the valve member within the valve body,

the valve mechanism and the valve body including complementary guide formations for guiding displacement of the valve mechanism relative to the valve body in an arrangement wherein rotation of the valve actuation member relative to the valve body causes rotational and axial displacement of the spindle and thereby the valve member relative to the valve body, causing the valve member to be displaced between an open position wherein it is spaced from the valve seat permitting the flow of liquid to the outlet opening and a closed position wherein the valve member is seated against the valve seat preventing liquid flow to the outlet opening,

the valve actuation member and the valve body including complementary sealing formations which co-operate to permit sealing sliding displacement of the valve actuation member relative to the valve body thereby providing a seal between the second end of the valve body and the outlet opening.

The valve member may include a generally cylindrical sealing formation. The valve seat may be in the form of an annular sealing formation defined by an internal side of the valve body. The valve member and the valve seat may be configured such that the sealing formation of the valve member is slidingly sealingly displaceable within the annular sealing formation of the valve seat in an arrangement wherein the sealing formation of the valve member forms a seal with the valve seat in the closed position of the valve member.

The sealing formation of the valve member and the annular sealing formation of the valve seat may be configured such that the sealing formation of the valve member is located within the sealing formation of the valve seat and forms a sliding interference fit therewith in the closed position of the valve member.

The valve body may define a longitudinal axis between the first and second ends thereof.

The complementary guide formations may be in the form of a spiral formation defined on one of the valve member and the valve body and a corresponding following protuberance defined on the other of the valve member and the valve body. More particularly, the spiral formation of the valve body and the protuberance of the valve member may be configured so as to co-operate to guide the axial and rotational displacement of the valve member within the valve body when the valve actuation member is rotated, in use.

The tap may be specifically configured so as to render it suitable for controlling the flow of liquids from bag-in-box containers, the valve body including a connecting formation for connecting the valve body to the outlet opening of a bag-in-box container.

### BRIEF DESCRIPTION OF THE DRAWINGS

Further features of the invention are described hereinafter by way of a non-limiting example of the invention, with reference to and as illustrated in the accompanying diagrammatic drawings. In the drawings:

FIG. 1 shows a schematic perspective view of a tap in accordance with the invention, located within an outlet opening of a bag-in-box container;

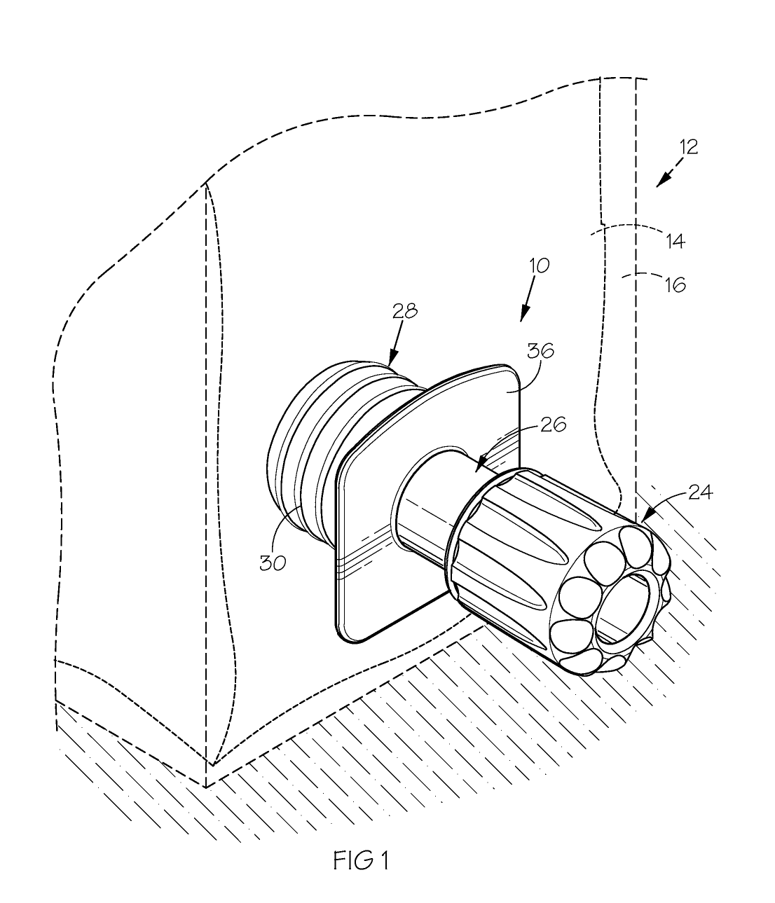

FIG. 2 shows a perspective view of the tap of FIG. 1, showing hidden detail;

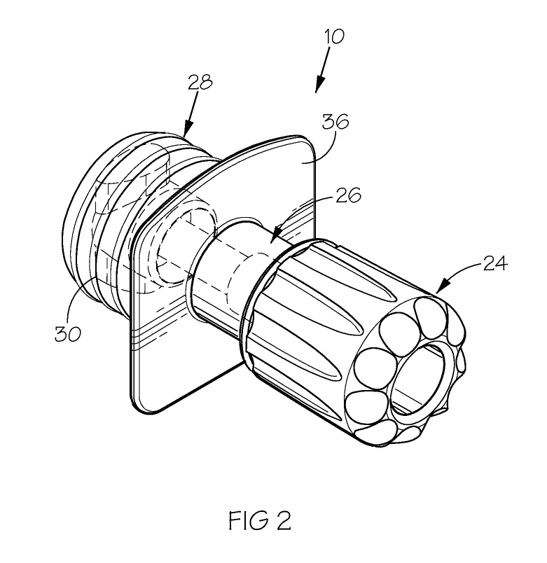

FIG. 3 shows an exploded perspective view of the tap of FIG. 1;

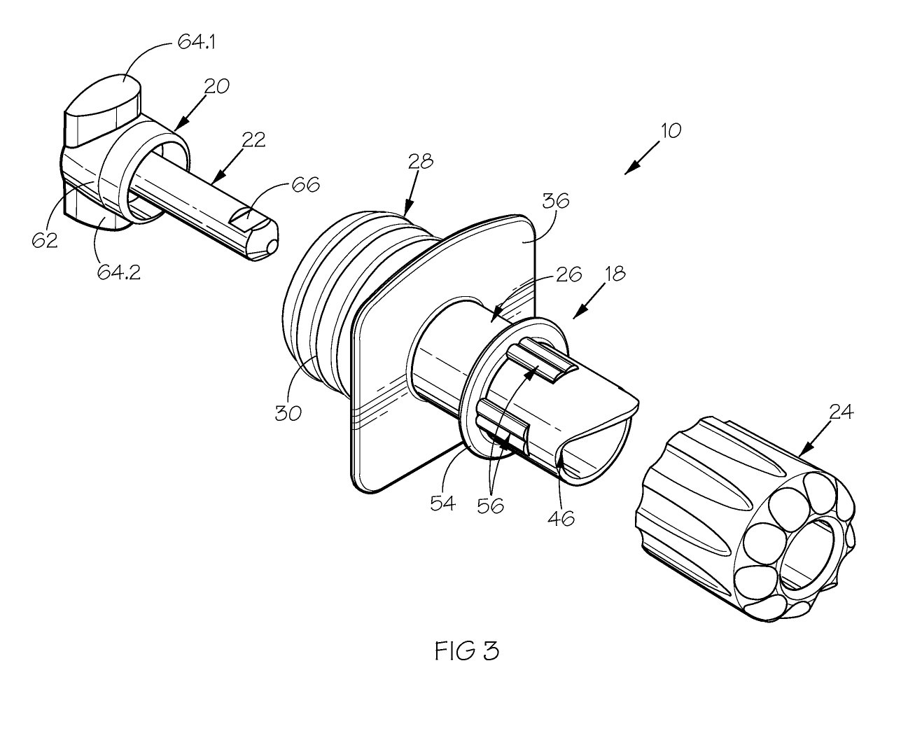

FIG. 4 shows a sectional side view of the valve body of the tap of FIG. 1;

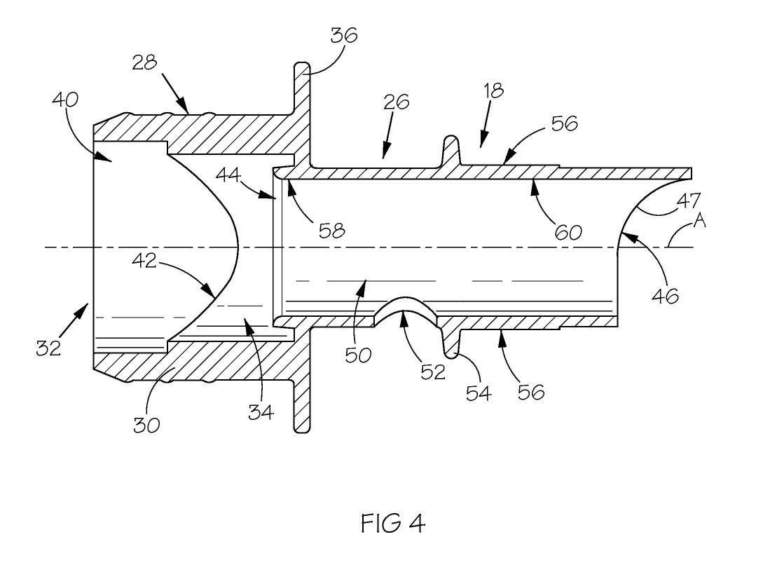

FIG. 5 shows a longitudinally-sectioned perspective view of the valve actuation member of the valve mechanism of the tap of FIG. 1;

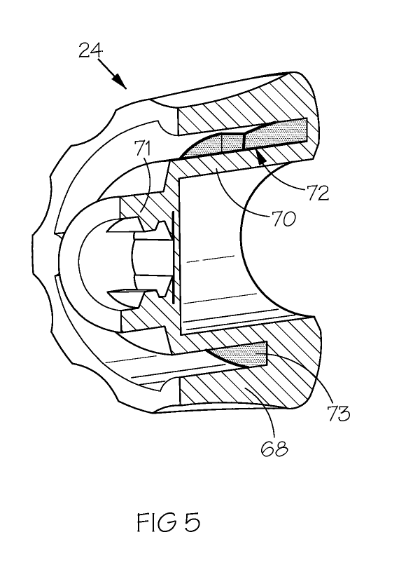

FIG. 6 shows a sectional side view of the tap of FIG. 1, showing the valve member in its closed position; and

FIG. 7 shows a sectional side view of the tap of FIG. 1, showing the valve member in its open position.

### DESCRIPTION OF PREFERRED EMBODIMENTS

With reference to the drawings, a tap for controlling the dispensing of a liquid from a container, in accordance with the invention, is designated generally by the reference numeral 10.

The tap 10 is specifically configured for use in controlling the dispensing of a liquid from a bag-in-box type container 12, which conventionally comprises a flexible bag 14 in which a liquid is held, housed within a rigid box 16. As such, the tap 10 is located within an opening defined in the box 16 and is connected in flow communication with an outlet opening of the bag 14 through which liquid from the bag is dispensed.

The tap comprises, broadly, a valve body 18 and a valve mechanism which includes a valve member 20, a spindle 22 and a valve actuation member 24. The valve body and the valve mechanism are of moulded synthetic plastics material.

The valve body 18 comprises a generally cylindrical passage-defining portion 26 and a generally cylindrical valve housing portion 28.

The valve housing 28 comprises a cylindrical wall portion 30 defining an inlet opening 32 at one end thereof and a valve chamber 34 within which the valve member 20 of the valve mechanism is movably located; and a flange 36 which extends perpendicularly outwardly relative to the cylindrical wall 30 at an end thereof remote from the end at which the inlet opening 32 is defined. More particularly, the inlet opening 32 leads into the valve chamber 34. The cylindrical wall 30 is configured and dimensioned such that an outer side 38 thereof can be sealingly fitted into the outlet opening of the bag 14 of the bag-in-box container 12 with an inner side of the flange 36 being secured against an outer face of the box 16.

An inner side of the cylindrical wall 30 defines an enlarged cylindrical cavity 40 within which the valve member 20 is locatable, in use, as will be explained in more detail hereinafter. The cylindrical wall further defines a spiral guiding formation 42 which projects inwardly from an inner side of the cylindrical wall 30, the purpose of which will also be explained in further detail hereinafter.

The passage-defining portion 26 has a generally cylindrical configuration and defines an open first end 44 and an open second end 46 which is disposed opposite the end 44. The passage-defining portion 26 defines an internal passage 50 which extends between the ends 44 and 46. As such, the passage-defining portion 26 defines a longitudinal axis A along the length thereof. The passage-defining portion 26 further defines an outlet opening 52 between the open ends 44 and 46. The passage-defining portion 26 further defines an outwardly projecting stop formation 54 against which the actuation member 24 abuts, in use, as will be explained in further detail hereinafter.

The end 46 of the passage-defining portion 26 defines a spiral guide formation 47 for guiding displacement of the actuation member 24 relative to the passage-defining section 26 as will be explained hereinafter. The passage-defining portion 26 further defines a number of circumferentially-spaced, longitudinally-extending locating ribs 56 which provide for location of the valve actuation member 24 relative to the passage-defining formation 26.

An inner side of the passage-defining formation 26 in the region of the open end 44 defines an annular sealing formation 58 within which the valve member 20 is slidingly sealingly displaceable, as will be explained in further detail hereinafter. An inner side of the passage-defining portion 26 near the end 46 thereof, defines an annular sealing formation 60 within which the valve actuation member is slidingly sealingly displaceable, as will be explained in further detail hereinafter.

The valve member 20 defines a cylindrical sealing formation 62 which is configured and dimensioned so as to fit into the annular sealing formation 58 of the passage-defining portion 26 in a sliding interference fit thereby to provide a sliding seal between the annular sealing formation 58 and the sealing formation 62 of the valve member. The valve member further defines a pair of guide formations in the form of radially-extending protuberances 64.1 and 64.2, which cooperate with the spiral guide formation 42 of the valve housing 28 in order to guide displacement of the valve member relative to the valve body 18, in use, as will be explained hereinafter.

The spindle 22 of the valve mechanism is integrally moulded with the valve member 20 and extends from a side of the valve member. The spindle defines a spigot-like connecting formation 66 at a distal end thereof remote from the valve member 20.

The valve actuation member 24 of the valve mechanism, comprises a generally cylindrical outer wall 68 and a generally cylindrical inner wall 70 which is spaced a predetermined distance from the outer wall 68. More particularly, an annular space is defined between the inner and outer walls within which an end region at the end 46 of the passage-defining portion 26 is received. The outer cylindrical wall 68 of the valve actuation member is configured and dimensioned so as to slidingly engage the rib formations 56 of the passage defining formation 26 in a particular rotational displacement of the valve actuation member relative to the passage-defining formation 26 as will be explained in more detail hereinafter.

The inner cylindrical wall 70 of the valve actuation member 24 defines a cylindrical sealing formation 72 which is dimensioned and configured so as to form a sliding cylindrical interference fit with the sealing formation 60 of the passage-defining portion 26 which provides for sealing sliding displacement of the valve actuation member relative to the passage-defining portion 26. The valve actuation member 24 includes a spiral guide formation 73 which cooperates with the spiral guide formation 46 at the end 46 of the passage-defining portion 26, thereby to facilitate guided displacement of the valve actuation member relative to the passage-defining portion 26 as will be explained hereinafter.

The valve actuation member defines a boss 71 defining a socket formation 74 in which the spindle 22 of the valve mechanism is located to provide for permanent connection of the spindle 22 to the valve actuation member 24 upon assembly of the components of the tap.

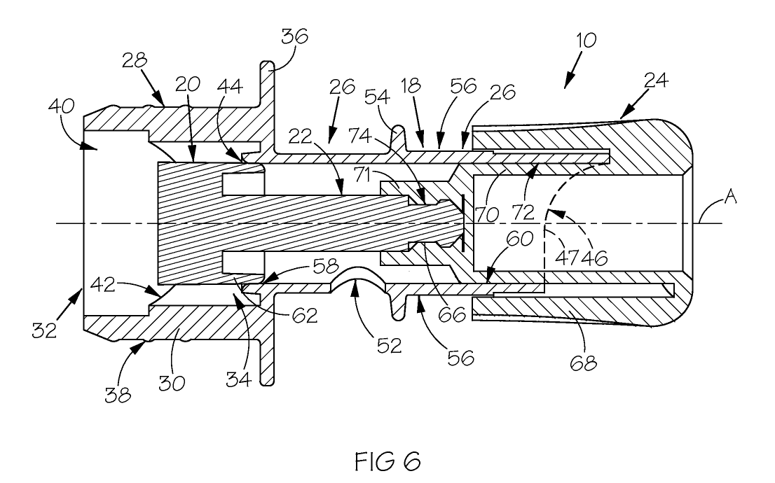

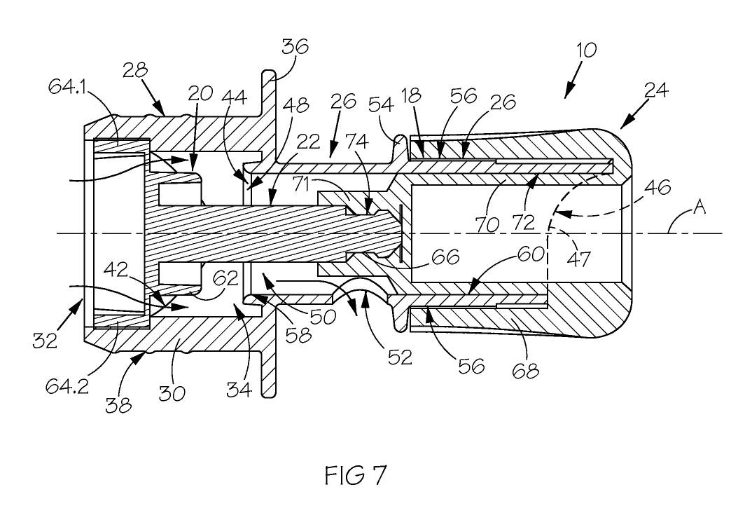

In use, the valve actuation member 24 is rotated about an axis of rotation which coincides with the longitudinal axis A defined by the passage defining portion 26, thereby to cause axial and rotational displacement of the spindle and thereby the valve member 20 relative to the valve body 18. More particularly, rotation of the valve actuation member 20 relative to the valve body causes rotational and axial displacement of the spindle and thereby the valve member relative to the valve body 18, causing the valve member 20 to be displaced between an open position (as is shown in FIG. 7 of the drawings) wherein it is spaced from the valve seat provided by the annular sealing formation 58 of the passage-defining portion 26 so as to permit liquid flow through the open end 44 of the passage-defining portion 26 to the outlet opening 52 thereof and a closed position (as is shown in FIG. 6 of the drawings) wherein the valve member 20 is seated against the valve seat defined by the passage-defining portion 26, thereby preventing liquid flow to the outlet opening 52. The guiding formation 47 of the passage-defining formation 26 and the guiding formation 73 of the valve actuation member 24 co-operate with one another as do the guiding formations 64.1 and 64.2 of the valve member 20 and the guiding formation 42 of the valve housing 28, to provide for guided axial and rotational displacement of the valve member 20 relative to the valve body 18 so as to facilitate guided displacement of the valve member 20 between its open and closed positions. In a fully open position of the valve member 20, the protuberances 64.1 and 64.2 are located within the cavity 40 defined by the valve housing 28 thereby releasably holding the valve member in its open position by restraining the valve member against axial displacement without rotation. In the fully open position, the inner side of the outer wall 68 of the valve actuation member is also frictionally gripped by the ribs 56 of the passage-defining portion 26, thereby resisting rotation of the valve actuation member and thereby the valve member.

The Applicant believes that the tap in accordance with the invention, can be manufactured with relative ease and at relatively low cost as it comprises only 3 components which are assembled to form the tap.

The Applicant believes further that the tap in accordance with the invention provides an effective and easy-to-use tap for dispensing liquids from containers.

1. A tap for controlling the dispensing of a liquid from a container, the tap including:
a valve body having an open first end and an opposite open second end, the first end being connectable to an outlet opening of the container and defining an inlet opening, the valve body defining an outlet opening between the first and second ends, the valve body further defining a tubular fluid flow passage and a valve seat between the inlet and outlet openings;
a valve mechanism including a valve member which is mounted within the valve body; a spindle which is connected to the valve member and which is rotatably mounted within the valve body; and a valve actuation member which is rotatably mounted to the valve body at the second end thereof and connected to the spindle in an arrangement wherein rotation of the valve actuation member causes rotation of the spindle and thereby the valve member within the valve body,
the valve mechanism and the valve body including complementary guide formations for guiding displacement of the valve mechanism relative to the valve body in an arrangement wherein rotation of the valve actuation member relative to the valve body, causes rotational and axial displacement of the spindle and thereby the valve member relative to the valve body, causing the valve member to be displaced between an open position wherein it is spaced from the valve seat permitting the flow of liquid to the outlet opening of the valve body and a closed position wherein the valve member is seated against the valve seat preventing liquid flow to the outlet opening of the valve body,
the valve actuation member and the valve body including complementary sealing formations which co-operate to permit sealing sliding displacement of the valve actuation member relative to the valve body thereby providing a seal between the second end of the valve body and the outlet opening,
the valve member and the valve seat including complementary sealing formations being configured such that the sealing formation of the valve member is slidingly sealingly displaceable within the sealing formation of the valve seat in an arrangement wherein the sealing formation of the valve member forms a seal with the sealing formation of the valve seat in the closed position of the valve member.

2. The tap as claimed in claim 1, wherein the sealing formation of the valve member has a generally cylindrical configuration.

3. The tap as claimed in claim 2, wherein the sealing formation of the valve seat is in the form of an annular sealing formation defined by an internal side of the valve body.

4. The tap as claimed in claim 3, wherein the sealing formation of the valve member and the annular sealing formation of the valve seat are configured such that the sealing formation of the valve member is located within the sealing formation of the valve seat and forms a sliding interference fit therewith in the closed position of the valve member.

5. The tap as claimed in claim 1, wherein the valve body defines a longitudinal axis between the first and second ends thereof.

6. The tap as claimed in claimed in claim 5, wherein the complementary guide formations of the valve mechanism and of the valve body are in the form of a spiral formation defined on one of the valve member and the valve body and a corresponding following protuberance defined on the other of the valve member and the valve body.

7. The tap as claimed in claim 6, wherein the spiral formation of the valve body and the protuberance of the valve member are configured so as to cooperate to guide the axial and rotational displacement of the valve member within the valve body when the valve actuation member is rotated, in use.

8. The tap as claimed in claim 1, wherein the tap is specifically configured so as to render it suitable for controlling the flow of liquids from bag-in-box containers, the valve body including a connecting formation for connecting the valve body to the outlet opening of a bag-in-box container.

9. (canceled)
